(19) United States
(12) Patent Application Publication
(10) Pub. No.: US 2021/0032810 A1
(43) Pub. Date: Feb. 4, 2021

(54) METHODS OF PRECONDITIONING FABRIC PRIOR TO INKJET PRINTING

(71) Applicant: Polymeric Ireland Limited, Dublin (IE)

(72) Inventors: Pramudi Abeydeera, Kansas City, MO (US); Deverakonda Sarma, Kansas City, MO (US)

(21) Appl. No.: 16/945,745

(22) Filed: Jul. 31, 2020

Related U.S. Application Data
(60) Provisional application No. 62/881,092, filed on Jul. 31, 2019.

(51) Int. Cl. D06P 5/30; B41M 5/00; D06P 5/12; D06P 5/20

(52) U.S. Cl. CPC D06P 5/30; B41M 5/0047; D06P 5/2072; D06P 5/12; B41M 5/0011

(57) ABSTRACT

Provided herein are processes and methods of preconditioning a fabric prior to the application of graphics using, for example, inkjet printing. The preconditioning may comprise one or more of the following: (1) applying a preconditioning formulation to all or a portion of the textile; (2) heating or drying the textile at an elevated temperature; and/or (3) exposing the textile to an inert gas or vacuum in order to remove excess unreacted dye material and/or making the dyes immobile or non-diffusive. Further the print will have less or no staining after printing and curing the fabric.

### CROSS-REFERENCE TO RELATED APPLICATION

This application claims the priority benefit of U.S. Provisional Patent Application Ser. No. 62/881,092, filed on Jul. 31, 2019, entitled “METHODS OF PRECONDITIONING FABRIC PRIOR TO INKJET PRINTING,” currently pending, the entire disclosure of which is incorporated herein by reference.

### FIELD

The present disclosure is generally directed to processes and methods of preconditioning a fabric prior to the application of graphics using, for example, inkjet printing or screen printing.

### BACKGROUND

Inkjet printing is a useful technique for applying graphics to a wide variety of substrates, including fabrics. For example, graphics are commonly applied to tee-shirts using a technique known as “direct printing,” which utilizes water-based pigment inks containing various resin compositions.

In a conventional direct printing process, an aqueous pretreatment composition is applied to at least a portion of the textile material that is to receive the ink image. The pretreatment composition typically comprises one or more polymer resins, and often includes other additives such as salts, surfactants, defoamers, and the like. Typically, the textile material containing the pretreatment composition is heated so as to remove moisture from the pretreatment composition and react the one or more polymer resins with the one or more other compounds thereby forming an image-receiving layer on the textile material. Following the pretreating step, white ink layer is typically deposited first on the pretreatment layer before printing with color inks (cyan, magenta, yellow, black and other spot colors based on the type of the printer).

The direct printing process often works well with fabrics composed of 100% cotton, as well as many cotton/polyester blends. Unfortunately, on synthetic substrates like 100% polyester, nylon, or other synthetic blends, conventional direct printing processes suffer from an issue known as dye migration, where dye applied to the base fabric migrates to the white ink layer. Such garments often suffer from dye migration and poor wash fastness issues even after applying the pretreatment step described above. The resulting color shifts are highly undesirable and frequently result in poor quality graphics that are unacceptable to customers.

In some situations, the substrate or item intended to receive an image is not amenable to direct printing operations due to staining and other undesirable print properties. In other situations, the volume of images to be printed makes direct printing operations economically unfeasible. It may also be desirable for printing operations to be performed at a site remote from the products to which the images will be applied. To address these issues, the textile and clothing industry has used ink transfers as a way of applying an image to, for example, an article of clothing. For example, U.S. Pat. No. 8,815,040, the entirety of which is incorporated herein by reference, is directed toward an ink transfer system for transferring ink images to synthetic textile materials.

Dye sublimation transfers have also been shown to provide certain benefits as compared to direct-to-substrate printing and other types of image transfer systems, particularly in regard to fabrics. Dye sublimation transfers are created by laying down reversed imagery onto transfer paper using dye-containing inks (as opposed to the pigmented inks that are conventionally used in direct printing systems). In a conventional dye sublimation process, the fabric and transfer paper are pressed together under high heat, typically about 200° C., which causes the dyes contained within the inks to flash sublimate. The vapor-phase dyes then migrate into the fabric's fibers, thereby transferring the image from the transfer to the fabric.

Dye sublimation has the ability to provide vibrant colors and transfer of highly detailed images that are limited only by the texture of the fabric and the resolution of the printer used in the manufacture of the transfer. Unfortunately, however, conventional dye sublimation processes do not work well in all fabric applications. For example, while dye sublimation can be used on cotton-containing fabrics to initially transfer an image to the fabric, the dyes generally do not adhere well to the cotton fibers. As a result, the transferred image is not durable and degrades very quickly, often upon a single wash cycle. Additionally, dye sublimation printing is not possible on darker colored fabrics, such as tee-shirts, and is therefore significantly limited in its applications.

Accordingly, there is a need in the art for a method that permits use of direct printing on a wide variety of substrates, including cotton, polyester, nylon, and blends of these and other materials.

### SUMMARY

Provided herein is a method for creating a printed textile comprising a graphical image, the method including a preconditioning step wherein a preconditioning formulation is applied to at least a portion of a textile, wherein the preconditioning formulation is an aqueous formulation comprising at least one or more of a dye blocker, stain remover, adhesion promoter, hydrophobic agent, among other additives, and a printing step wherein one or more inks are applied to the textile, thereby forming a graphical image on the textile.

Also provided herein is a method for creating a printed textile comprising a graphical image, the method including a preconditioning step wherein a textile is dried at an elevated temperature prior to printing; and a printing step wherein one or more inks are applied to the textile later, thereby forming a graphical image on the textile.

Also provided herein is a method for creating a printed textile comprising a graphical image, the method including a preconditioning step wherein a textile is exposed to an inert gas prior to printing; and a printing step wherein one or more inks are applied to the textile, thereby forming a graphical image on the textile.

Further provided herein is a printed textile comprising a graphical image, wherein said printed textile is prepared according to a method as disclosed herein.

These and other aspects of the present disclosure are described in further detail below.

### DESCRIPTION OF THE FIGURES

The patent or application file contains at least one drawing executed in color. Copies of this patent or patent application publication with color drawing(s) will be provided by the Office upon request and payment of the necessary fee.

FIG. 1 illustrates polyester fabric samples processed without a preconditioning step, as described in Example 3. As shown in the figure, dye migration from the shirt altered the white ink to orange after the heat curing step.

FIG. 2 illustrates polyester fabric samples processed with a preconditioning step, as described in Example 3. As shown in the figure, no dye migration is visible.

### DETAILED DESCRIPTION

Provided herein are processes and methods for applying graphics to fabrics. The methods provided herein may include a preconditioning step, where needed, to control the dye migration, excessive staining and other adhesion issues conventionally associated with water-based pigment inks that are described in detail above.

The methods provided herein may be used to apply graphics to any suitable fabric known to those skilled in the art. Non-limiting examples of fabrics that may be printed using the provided methods include cotton, polyester, nylon, and blends of these and other materials. For example, the method may comprise applying graphics to a textile that includes polyester fabric.

### Preconditioning Step

The methods provided herein may include a preconditioning step comprising one or more of the following: (1) applying a preconditioning formulation to all or a portion of the textile; (2) heating or drying the textile at an elevated temperature; and/or (3) exposing the textile to an inert gas.

The preconditioning step may include applying a preconditioning formulation to the textile to be printed. The preconditioning formulation may be applied to the entire textile or a portion thereof. For example, the textile may be dipped or immersed in the preconditioning formulation. Alternatively, the preconditioning formulation may be applied to the textile by spraying or jetting (e.g., using a valve jet or inkjet nozzle).

The preconditioning formulation may be an aqueous formulation. In preferred embodiments, the preconditioning formulation comprises a dye blocker solution. A dye blocker essentially consists of a group of salts, surfactants, stain removers, and adhesion promoters that react with or neutralize the unreacted dyes on the shirt material. The salts can be, but are not limited to, cationic, anionic or non-ionic so as to make the dyes immobile or non-diffusive once heated above room temperature. Furthermore, it can be exposed to an inert gas or vacuum to remove the excess unreacted dye material. The dye blocker may also optionally contain a resin, surfactant, corrosion inhibitor, adhesion promoter, a hydrophobic agent and/or a defoamer, based on the application method used to condition the fabric.

The preconditioning step may comprise heating or drying the textile at an elevated temperature. For example, the textile may be dried at a temperature of at least about 90° C., at least about 120° C., at least about 125° C., at least about 130° C., at least about 135° C., at least about 140° C., at least about 145° C., at least about 150° C., or at least about 155° C., or at least about 160° C. In some embodiments, the textile may be dried at a temperature of from about 100° C. to about 225° C., for example from about 120° C. to about 220° C. from about 100° C. to about 200° C., from about 150° C. to about 190° C., or from about 160° C. to about 175° C. The textile may be dried at one or more of the temperatures listed above for a period of at least about 15 seconds, at least about 30 seconds, at least about 45 seconds, at least about 1 minute, at least about 1 minute 15 seconds, or at least about 1 minute 30 seconds. For example, the textile may be dried for a period of from about 30 seconds to about 60 minutes, from about 1 minute to about 10 minutes, or from about 1 minute 30 seconds to about 6 minutes 30 seconds.

The preconditioning step may comprise exposing the textile to at least one of an inert gas, a plasma treatment, and a corona treatment. The inert gas may be one of a noble gas. a plasma gas and a corona discharge. For example, the inert gas may be selected from the group consisting of helium and argon. Preferably, the textile is exposed to an atmosphere comprising the inert gas in a concentration of at least about 25%, at least about 50%, at least about 70%, at least about 80%, or at least about 90% on a molar basis. The textile may be exposed to the inert gas for a period of at least about 15 seconds, at least about 30 seconds, at least about 45 seconds, at least about 1 minute, at least about 1 minute 15 seconds, or at least about 1 minute 30 seconds. For example, the textile may be exposed to the inert gas for a period of from about 30 seconds to about 60 minutes, from about 1 minute to about 10 minutes, or from about 1 minute to about 5 minutes. Alternatively, the fabrics can be exposed to an inert gas in a chamber for a day or more to condition the fabric.

### Printing Steps

Following the preconditioning step, graphics may be applied to the textile using one or more printing steps. For example, graphics may be applied to the textile using conventional inkjet printing techniques. The printing steps may include one or more of: (1) application of a pretreatment composition; (2) application of a white ink composition; (3) application of one or more colored inks; and/or (4) application of a top coating.

Pretreatment Application

The method may further comprise a pretreatment step wherein a pretreatment composition is applied to the textile. Typically, the pretreatment composition is applied to the portion of the textile that is to be printed using a valve jet nozzle or an inkjet nozzle. Once the pretreatment composition has been applied, the textile may be subjected to a drying step. For example, the textile may be dried using infrared (IR) lamps or through a convection oven, such as gas dryer with a conveyor belt.

White Ink Application

The method may further comprise a step wherein a white ink layer is applied to the textile. For example, the white ink layer may be applied to the portion of the textile that is to be printed using an inkjet nozzle. Once the white ink layer has been applied, the textile may be subjected to an additional drying step. For example, the textile may be dried using infrared (IR) lamps.

Colored Ink Application

The method may further comprise a step wherein colored inks are applied to the textile. Typically, the colored inks may be applied using an inkjet nozzle. Once the colored inks been applied, the textile may be subjected to an additional drying step. For example, the textile may be dried using infrared (IR) lamps.

Top Coat Application

The method may further comprise a step wherein colored inks are applied to the textile. The top coating may be applied, for example, using an inkjet nozzle or a valve jet nozzle.

### Curing Step

The method may further comprise a curing step wherein the printed textile is subjected to an elevated temperature. For example, the textile may be cured at a temperature of at least about 90° C., at least about 120° C., at least about 125° C., at least about 130° C., at least about 135° C., or at least about 140° C. In some embodiments, the textile may be cured at a temperature of from about 90° C. to about 200° C., for example from about 100° C. to about 200° C., from about 120° C. to about 175° C., from about 130° C. to about 160° C., or from about 135° C. to about 150° C. The textile may be cured at one or more of the temperatures listed above for a period of at least about 15 seconds, at least about 30 seconds, at least about 45 seconds, at least about 1 minute, at least about 1 minute 15 seconds, or at least about 1 minute 30 seconds. For example, the textile may be cured at an elevated temperature for a period of from about 30 seconds to about 60 minutes, from about 1 minute to about 20 minutes, from about 2 minutes to about 10 minutes, or from about 4 minutes to about 8 minutes.

### Printed Textile

Also provided is a printed textile comprising a graphical image that is prepared using a method as described above.

In preferred embodiments, the printed textile is capable of withstanding at least 10, at least 15, or at least 25 washing cycles or more while still exhibiting only minor amounts of fading of the graphical image.

Preferably, the graphical image remaining after the washing cycles is considered industrially acceptable and retains at least about 70% of the original color density as measured by a spectro-densitometer (for example, at least about 80%, at least about 90%, or at least about 95% of the original color density) even after 5, 10, 15, or 25 washing cycles.

Preferably, the printed textile avoids discernable yellowing of the textile material upon heating and curing of the applied graphics composition, with or without application of a top coat. Further, there will less or no visible staining on the fabrics once printed.

Other objects and features will be in part apparent and in part pointed out hereinafter.

### EXAMPLES

The following non-limiting examples are provided to further illustrate the present disclosure.

### Example 1

The components described below were used in each of the following examples, unless otherwise indicated.

In each of the following examples, the preconditioning formulation was an aqueous formulation comprising a dye blocker as described herein.

The fabric samples used in the following examples are described in Table 1 below.

TABLE 1

| Sample | Fabric Type | Color |
|---|---|---|
| 1 | 100% polyester tee-shirt | Red |
| 2 | 100% polyester tee-shirt | Red |
| 3 | 100% polyester tee-shirt | Red |
| 4 | 100% polyester tee-shirt | Red |
| 5 | 100% polyester tee-shirt | Black |
| 6 | 100% polyester tee-shirt | Blue |
| 7 | 100% polyester tee-shirt | Red and Black |
| 8 | 100% polyester tee-shirt | Red |

### Example 2

The fabric samples described in Example 1 were each subjected to pretreatment steps, as described in Table 2 below.

TABLE 2

| Sample | Preconditioning Step |
|---|---|
| 1 | No preconditioning (control) |
| 2 | Sample was oven dried at 160-175° C. for 6:30 (6 minutes 30 |
| | seconds), then cooled to room temperature. |
| 3 | Sample was dipped in the preconditioning formulation, then |
| | dried at room temperature. |
| 4 | Sample was dipped in the preconditioning formulation, dried |
| | in an oven at 160-175° C. for 6:30, then cooled to room |
| | temperature. |
| 5 | Sample was sprayed with the preconditioning formulation, |
| | dried in an oven at 160-175° C. for 6:30, then cooled to |
| | room temperature. |
| 6 | Sample was sprayed with the preconditioning formulation, |
| | washed with water, dried in an oven at 160-175° C. for 6:30, |
| | then cooled to room temperature. |
| 7 | Sample was dipped in the preconditioning formulation, dried |
| | in an oven at 160-175° C. for 1:30, then cooled to room |
| | temperature. |
| 8 | Sample was exposed to an inert gas (helium) for 1-5 hours. |

### Example 3

Following the pretreatment steps described in Example 2 above, the samples were exposed to room conditions (i.e., ambient temperature and humidity) and were then prepared for printing using an inkjet press. First, a pretreatment composition was applied to each sample and dried using a row of IR lamps. Next, a white ink layer was applied to each sample and dried using an IR lamp. Next, a colored ink layer was applied to each sample, using either CMYK inks or CMYK, red and green inks based on the printer configuration. Some of the printers were equipped to lay down a top coat on the top of the printed layer; during these runs, the top coat was applied in-line with a sprayer or using a valve jet.

After completion of the printing process, each sample was sent through a convection oven set at 143° C. for 6:30 (6 minutes 30 seconds). Once each sample was fully cured, the samples were examined for signs of dye migration. Each sample was then sent through a washing cycle to test for wash fastness of the applied graphics.

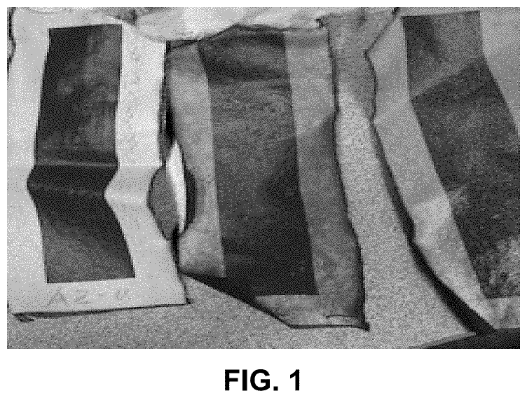

As shown in FIG. 1, for the samples processed without a preconditioning step (Sample #1), significant dye transfer was visible. More specifically, it was observed that unreacted dye from the fabric mixed with the white ink layer and shifted the color, as shown in the figure.

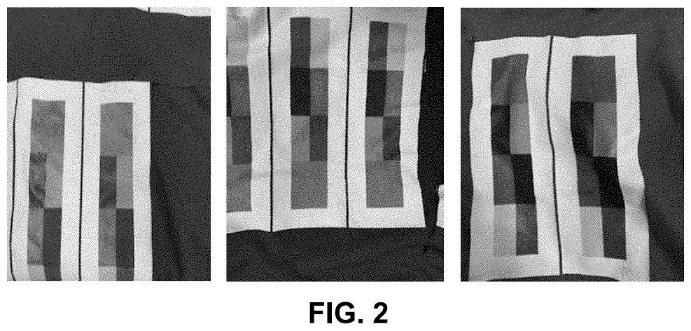

As shown in FIG. 2, for the samples that were subjected to a preconditioning step (Samples #2-8), no dye transfer was visible. Furthermore, the wash fastness of the fabrics was significantly improved, regardless of whether a top coat was applied. The finished textile products exhibited excellent washability characteristics, capable of withstanding at least five washing cycles (e.g., using a household washing machine and detergent) without any observable fading of the image.

When introducing elements of the present disclosure or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

In view of the above, it will be seen that several objects of the disclosure are achieved and other advantageous results attained.

As various changes could be made in the above products and methods without departing from the scope of the disclosure, it is intended that all matter contained in the above description shall be interpreted as illustrative and not in a limiting sense.

What is claimed is:

1. A method for creating a printed textile comprising a graphical image, the method comprising:
a preconditioning step wherein a preconditioning formulation is applied to at least a portion of a textile, wherein the preconditioning formulation is an aqueous formulation comprising a dye blocker; and
a printing step wherein one or more inks are applied to the textile, thereby forming a graphical image on the textile.

2. The method of claim 1 wherein the preconditioning step further comprises drying the textile at an elevated temperature, prior to printing.

3. The method of claim 1 wherein the preconditioning step further comprises exposing the textile to at least one of an inert gas, a plasma treatment, and a corona treatment, prior to printing.

4. The method of claim 1 wherein the dye blocker further comprises an adhesion promoter and a hydrophobic agent.

5. A method for creating a printed textile comprising a graphical image, the method comprising:
a preconditioning step comprising drying a textile at an elevated temperature; and
a printing step wherein one or more inks are applied to the textile, thereby forming a graphical image on the textile.

6. The method of claim 5 wherein the preconditioning step comprises drying the textile at a temperature of from about 150° C. to about 190° C.

7. The method of claim 6 wherein the textile is dried for a period of from about 1 minute 30 seconds to about 6 minutes 30 seconds.

8. A method for creating a printed textile comprising a graphical image, the method comprising:
a preconditioning step comprising exposing the textile to an inert gas; and
a printing step wherein one or more inks are applied to the textile, thereby forming a graphical image on the textile.

9. The method of claim 8 wherein the inert gas is at least one of a noble gas, a plasma gas and a corona discharge.

10. The method of claim 9 wherein the inert gas is selected from the group consisting of helium and argon.

11. The method of claim 8 wherein the textile is exposed to an atmosphere comprising the inert gas in a concentration of at least about 70% on a molar basis.

12. The method of claim 8 wherein the textile is exposed to the inert gas for a period of from about 1 minute to about 5 minutes.

13. The method of claim 1 further comprising a pretreatment step wherein a pretreatment composition is applied to the textile.

14. The method of claim 1 wherein the printing step is an inkjet printing step wherein one or more inks are applied to the textile using an inkjet nozzle.

15. The method of claim 1 further comprising a curing step wherein the printed textile is subjected to an elevated temperature.

16. The method of claim 15 wherein the curing step comprises heating the printed textile at a temperature of from about 90° C. to about 175° C.

17. The method of claim 15 wherein the curing step comprises heating the printed textile for a period of from about 1 minute to about 15 minutes.

18. A printed textile prepared according to the method of claim 1.

19. The printed textile of claim 18 wherein said printed textile is capable of withstanding at least 10 washing cycles while still exhibiting only minor amounts of fading of the graphical image.

20. The printed textile of claim 18 wherein the graphical image retains at least about 70% of its original color density as measured by a spectro-densitometer after 10 washing cycles.

21. The printed textile of claim 18 wherein said printed textile avoids discernable yellowing of a textile material upon heating and curing of an applied graphics composition.
